(19) United States
(12) Patent Application Publication
(10) Pub. No.: US 2010/0266856 A1
(43) Pub. Date: Oct. 21, 2010

(54) CROSS-LINKABLE SILICONE COMPOSITION FOR PRODUCING NON-STICK COATINGS FOR POLYMER FILMS

(75) Inventors: John White, Chessy Les Mines (FR); Sean Duffy, Lyon (FR); Michel Feder, Villeurbanne (FR); Alain Pouchelon, Meyzieu (FR)

Correspondence Address: PEARNE & GORDON LLP, 1801 EAST 9TH STREET, SUITE 1200, CLEVELAND, OH, 44114-3108, US

(73) Assignee: BLUESTAR SILICONES FRANCE SAS, Lyon (FR)

(21) Appl. No.: 12/302,039

(22) PCT Filed: May 31, 2007
(86) PCT No.: PCT/EP07/55347

§ 371 Date: Oct. 28, 2009

(30) Foreign Application Priority Data
May 31, 2006 (FR) 0651992

(51) Int. Cl. C09D 183/04; B05D 3/02; B32B 27/08

(52) U.S. Cl. 428/447; 524/588; 427/387

(57) ABSTRACT

Silicon compositions with the silicon compound ingredient A alkenylated PolyOrganoSiloxane (POS) containing an F1 fraction and an F2 fraction that are different from each other; F2, an adherence enhancer comprising a linear monoalkenylated silicon oil (A_{2.1}) at one of its ends and/or a long linear α,ω,-alkenylated silicon oil (A_{2.2}) and/or a “weakly alkenylated linear oil. Applications: non-stick silicon coatings obtained from crosslinking/polyaddition for PET.

The field of the invention is that of cross-linkable or cross-linked silicone compositions, capable of being used, in particular, to form a coating or water-repellent and non-stick film for flexible supports preferably in the form of natural or synthetic polymer films.

These curable, non-stick silicone compositions are applied to such supports, in order to facilitate the removal of adhesive materials laminated in a reversible manner on these supports.

More precisely, the invention relates to the silicone compositions of the type of those comprising:
functionalized polyorganosiloxanes (POSs) carrying, on the same molecule or not on the same molecule, Si—H [(M)_{a′≧0} (M^{H})_{b′≧0} (D^{H})_{c′≧0} (D)_{d′≧0}] and Si-alkenyl, preferably Si-vinyl (Vi) [(M)_{a″≧0} (M^{Vi})_{b″≧0} (D^{Vi})_{c″≧0} (D)_{d″≧0}] units; the Si—H units being capable of reacting with the Si-alkenyl units by addition reaction;
an appropriate metal catalyst preferably platinum;
optionally at least one adhesion modulating system, for example based on silicone resin comprising siloxyl units Q: (SiO_{4/2}) and/or T: (RSiO_{3/2});
optionally other additives (fillers, accelerators, inhibitors, pigments, surfactants etc.).

The invention also relates to the preparation of this type of silicone composition.

The invention also relates to the methods for producing silicone coatings e.g. water-repellent and/or non-stick coatings for flexible supports (e.g. polymer films), from the abovementioned compositions.

These liquid silicone compositions are applied to the support films in industrial coating devices comprising cylinders operating at very high speed (for example 600 m/min). It is clear that in these very high-speed coating procedures, the viscosity of the liquid silicone coating composition must be meticulously adapted to the coating operation conditions.

In practice, the deposition rate of non-stick silicone is comprised between 0.1 and 2, preferably 0.3 and 1 g/m², which corresponds to thicknesses of the order of a micrometre.
Once applied to the flexible support, the silicone composition cross-links to form a solid non-stick and/or water-repellent silicone coating (e.g. elastomer).
Given the very high-speed industrial coating rates, the cross-linking kinetics must be extremely rapid in order to produce a correct cross-linking, i.e. the non-stick silicone films must be sufficiently cross-linked to be able best to perform their non-stick function and possess the desirable mechanical qualities. The evaluation of the quality of the cross-linking of the non-stick silicone film can in particular be carried out by means of an assay of the non-cross-linked extractable compounds, the quantity of which must be reduced as much as possible. For example, the level of extractables is preferably less than 5%, under normal industrial cross-linking conditions.
The non-stick quality of the outer surface which is free from the silicone coating is expressed by means of the peel force, which must be weak and controlled, for the element intended to be arranged on the support coated by the non-stick silicone film. In a standard fashion, this element can be the adhesive surface of a label or a tape of the same name. Thus, in addition to this low and controlled non-stick quality, the adhesion of the silicone coating to its support must be very high. This adhesion property is judged for example using the “rub off” test, which involves rubbing the surface of the coating with a finger and measuring the number of successive passes which lead to a degradation of the coating.
It is also important that these silicone coating compositions, which are cross-linkable by hydrosilylation e.g. Si—H/Si-Vi, have the longest possible service life at ambient temperature, when they are in the form of a coating bath in industrial coating machines. Flexible supports coated with a non-stick silicone film can be for example:
an adhesive tape the inner surface of which is coated with a pressure-sensitive layer of adhesive and the outer surface of which comprises the non-stick silicone coating;
or a paper or a polymer film for protecting the adhesive surface of a self-adhesive or pressure-sensitive adhesive element;
or a polymer film of polyolefin type (Polyvinyl chloride (PVC), Polypropylene or Polyethylene) or of polyester type (PolyEthyleneTerephthalate—PET—).
   Within the framework of the present invention, there is more particular interest in liquid silicone compositions for coating flexible polymer supports (polyester e.g. made of PET). In fact, one of the advantages of PET films is due to their very small thickness (20 μm) which makes it possible to significantly limit the bulk of rolls of film.
   Moreover, for obvious reasons of handling safety and toxicity, the present invention relates to solvent-free silicone compositions.
   Now, in order to be sufficiently cured/cross-linked, these liquid solvent-free silicone compositions, which cross-link by polyaddition (Si—H/Si-alkenyl—e.g. vinyl-), must preferably be cross-linked under heat activation. These reaction conditions are not suitable for certain heat-sensitive supports such as those comprising polyethylene (PE), such as for example PE films or papers layered with PE, or those of the thermal print paper type. These heat-sensitive supports do not withstand heating to temperatures above 90° C. The whole difficulty is therefore to obtain, for these heat-sensitive supports, correct cross-linking at low temperatures, for example less than or equal to 110° C. (85-90° C.).
   On the other hand, for flexible polyester supports, for example made of PET, it is possible to utilize higher temperatures for heat cross-linking (or activation), but given the very high industrial coating speeds, the residence time in the oven is very short, for example of the order of 2 seconds. Obtaining correctly cross-linked silicone coatings therefore also remains a concern for polyester supports, in particular made of PET.
   Moreover, it transpires that most of the silicone coating compositions currently used for flexible PET supports contain organic solvents. It would therefore be extremely desirable to propose solvent-free silicone coating compositions, in particular for polyester supports, e.g. made of PET, which cross-link/cured correctly under industrial coating conditions. Beyond this aspect, it is essential that, from an economic point of view, these solvent-free silicone coating compositions, in particular for supports made of polymer, in particular made of polyester, e.g. made of PET, can be used on standard industrial coating equipment suitable for flexible supports made of paper. This assumes that said compositions have a relatively low viscosity (for example less than or equal to 1000 mPa·s) to facilitate their handling, in order to have a good coating quality and to reduce the problem of misting which appears at very high industrial coating speeds.
   Another constraint to be taken into account for the formulation of the liquid silicone coating compositions is that the coefficient of friction of the cross-linked silicone elastomer coating should be controllable, in order to facilitate rolling/unrolling operations and the cutting out into sheets (“trimming”) of the flexible polymer supports (in particular made of polyester such as PET), which are useful as “liners” for labels.
   It is important for this application that the silicone coating elastomer is detrimental neither to the smoothness, nor to the transparency, nor to the mechanical properties of the support. The smoothness is necessary for precision trimming at very high speed. The transparency is imperative for inspection of the uniformity of the film always at very high speed, using optical detectors.
   Beyond the properties referred to above for the polymer supports (in particular polyester, e.g. PET), the adhesion or attachment of the silicone coating to the support (manifested by the “rub-off” abrasion resistance) should be optimum and stable over time.
   And since it is a non-stick coating, control of the peel force is also important. Advantageously, this control must be effective at low and at high speed. The balance between the low speed peel forces and the high speed peel forces is commonly called the non-stick profile. This non-stick profile is dependent on several factors such as the material of the labels, the flexible polymer support, the adhesive and the formulation of the silicone coating. As regards polyester supports in particular, a well-known problem is that the high speed peel force is too low when solvent-free silicone compositions with thermal cross-linking are used. Improvements are therefore desirable in this regard.

Now, the technical propositions known at present do not satisfy the abovementioned specifications, in particular vis-à-vis flexible polymer supports, in particular made of polyester (e.g. PET).

For example, the U.S. Pat. No. 4,774,111 discloses in particular non-stick silicone compositions for paper supports comprising linear POSs M^{Vi}DₙM^{Vi} with a viscosity of 100-100,000 mPa·s, preferably 100-5,000 mPa·s, linear POSs with Si—H units, a platinum catalyst and, inter alia, a cross-linking inhibitor.

The Application US-A-2004/0161618 describes non-stick silicone compositions having improved adhesion to paper or polymer supports. These compositions include a POS of MDM type bearing active functional grafts of epoxy, oxirane or carboxy type for promoting the attachment of the silicone coating, as well as alkenylated linear POSs M^{Vi}₂₋₅ D₅₀₋₁₀₀₀ T_{a′″≧0} M_{0-0.5}, linear POSs with Si—H units, a platinum catalyst and, inter alia, a cross-linking inhibitor.
The Application WO-A-2004/046267 discloses a non-stick silicone coating having improved anchorage properties on PET “liner” type supports, without this being detrimental to the cross-linking (curing). The cross-linkable silicone composition at the origin of this coating, contains an alkenylated POS resin M^{Vi} D₁₅₋₉₉₅ Q_{a′″≧0}, linear POSs with Si—H units, a non-alkenylated POS resin of PolyDiMethylSiloxane type with a viscosity of 10-200,000 mPa·s, e.g 100, 13,500, 60,000 mPa·s, a platinum catalyst and, inter alia, a cross-linking inhibitor.

In this context, the essential objective of the present invention is to propose novel solvent-free liquid silicone coating compositions which are cross-linkable in a non-stick and/or water-repellent coating for flexible supports, instantaneously and leading to cross-linked silicone coatings of very good quality, in particular in terms of attachment/adhesion to the “high rub-off” support and with a non-stick profile (peel force at a sufficiently high speed).

Another essential objective of the invention is to propose novel solvent-free liquid silicone coating compositions which can be rapidly cross-linked in a non-stick and/or water-repellent coating for flexible supports, in particular for polymer films, for example made of polyester of the PET type, the cross-linked coating obtained having:
on the one hand, sufficient cross-linking to have suitable mechanical and adhesion properties of the coating,
and, on the other hand, a low level of extractables for a good permanence of the non-stick properties which is in particular favourable for cutting out into sheets (“trimming”) of said support films of the “liner” type for labels.

Another essential objective of the invention is to propose solvent-free novel liquid silicone coating compositions, which are cross-linkable in a non-stick and/or water-repellent coating for flexible supports, in particular for polymer films, for example made of polyester of the PET type, this cross-linking taking place rapidly at low temperature, instantaneously, these compositions being moreover endowed with long service lives in the bath, at ambient temperature.

Another essential objective of the invention is to propose novel solvent-free liquid silicone coating compositions, which are cross-linkable in a non-stick and/or water-repellent coating for flexible supports, in particular for polymer films, for example made of polyester of the PET type, these compositions having the low viscosities suitable for methods for producing non-stick coatings at high speed, including on standard equipment provided for paper supports, without giving rise to recalcitrant problems of “misting”.

Another essential objective of the invention is to propose novel liquid silicone coating compositions which are cross-linkable in a non-stick and/or water-repellent coating for flexible supports, easy to prepare and economical.

Another essential objective of the invention is to propose a novel process for producing a coating which is water-repellent and non-stick on a support, preferably a polymer film, more preferably a polymer film made of polyester (for example of PET) having the sought properties of attachment ((“rub-off”), of control of the peel force profile, with a low level of extractables) and appropriate coefficient of friction, all with a solvent-free starting composition, with a viscosity compatible with high speed coating without “misting”.

Another essential objective of the invention is to propose a novel process for increasing the attachment (i.e. the abrasion resistance) of a cross-linked/cured silicone coating which is water-repellent and non-stick, applied to a support, preferably a polymer film, more preferably a polymer film made of polyester, and obtained from a silicone composition capable of cross-linking/curing by polyaddition, while retaining or even improving the control of the peel force profile, the low level of extractables and the appropriate coefficient of friction, all with a solvent-free starting composition, with a viscosity compatible with high speed coating without “misting”.

Another essential objective of the invention is to propose a novel support, preferably a polymer film, more preferably a polymer film made of polyester (PET), having at least one non-stick, water-repellent coating, based on a silicone composition cross-linked/cured by polyaddition, and having excellent attachment properties ((“rub-off”), control of the peel force profile, hardness (% of extractables) and with an appropriate coefficient of friction, all starting with a solvent-free starting composition, with a viscosity compatible with high speed coating without “misting”.

These objectives, among others, are achieved by the present invention which relates firstly to a novel silicone composition capable of cross-linking/curing by polyaddition, to form a coating which is water-repellent and non-stick for supports preferably in the form of polymer films, characterized in that it comprises:
(A) an alkenylated silicone component containing at least one functional silicone oil comprising at least one PolyOrganoSiloxane (POS) comprising units of formula:

$${W}_{a} {Z}_{b} SiO \frac{4 - ( a + b )}{2} \qquad ( I .1 )$$

in which:
   W represents independently a functional alkenyl group, preferably C2-C6, and, still more preferably vinyl or allyl,
   Z represents independently a monovalent hydrocarbon group, with no unfavourable effect on the activity of the catalyst and chosen, preferably, from the alkyl groups having 1 to 8 carbon atoms advantageously included among the methyl, ethyl, propyl and 3,3,3-trifluoropropyl groups as well as among the aryl groups and, advantageously, among the xylyl and totyl and phenyl radicals,
   a is 1 or 2, b is 0, 1 or 2 and a+b is comprised between 1 and 3;
this alkenylated silicone component A comprising a fraction F1 and a fraction F2 which are different from one another,
fraction F1 comprising at least one alkenylated silicone oil chosen from the group comprising at least one linear POS having, per molecule, at least two alkenyl groups (preferably C₂-C₆) bound to the silicon,
   of average linear formula: M^{w}ᵣ(D)_{q}(D^{w})_{q′}M_{r′} in which M and D are siloxy units of formula (I.1) with for M: a=0, b=3, for M^{w}: a=1, b=2 and for D: a=0, b=2, D^{w}: a=1, b=1; q and q′ are natural integers, r,r′=0, 1 or 2 with r+r′=2;
   of viscosity v4 (in mPa·s at 25° C.) defined as follows:
   75≦v4≦4,000, preferably 100≦v4≦2,000, and better still 100≦v4≦1,000
   and with a mass ratio R^{w} (% by weight) of the Si-alkenyl units to the total mass of the POS of the fraction F1 of A is defined as follows:
      0.1≦R^{w}≦3.5, preferably 0.2≦R^{w}≦3, and better still 0.5≦R^{w}≦3,
F2 having an activity which promotes the adhesion on the supports (therefore of the abrasion resistance) of the non-stick coatings obtained by curing/cross-linking of the composition,
and F2 being formed by at least one alkenylated silicone oil chosen from the group comprising:
   (A_{2.1}) the monoalkenylated silicone oils each comprising at least one linear POS having, per molecule, a single end bearing a single alkenyl group (preferably C₂-C₆) bound to the silicon, and of average linear formula M^{w}DₘM in which M, M^{w} and D are siloxy units of formula (I.1) with for M: a=0, b=3; M^{w}: a=1, b=2 and for D: a=0, b=2; and m is a natural integer greater than or equal to 150;
   (A_{2.2}) the long silicone oils each comprising at least one linear POS having, per molecule, at each of its ends an alkenyl group (preferably C₂-C₆) bound to the silicon and of average linear formula M^{w}DₙM^{w} in which M^{w} and D are siloxy units of formula (I.1) with for M^{w}: a=1, b=2 and for D: a=0, b=2; and n is a natural integer greater than or equal to 250; the viscosity v2 of said oils A_{2.2} being comprised between 3000 and 200,000 mPa·s;
   (A_{2.3}) the “weakly” alkenylated silicone oils each comprising at least one linear POS having, per molecule, at least one alkenyl group (preferably C₂-C₆) bound to the silicon, of average linear formula (M^{w})ₓ(M)_{y}(D)ₚ(D^{w})_{p′} in which M, M^{w} and D are siloxy units of formula (I.1) with for M,M^{w}: a=1, b=2 and for D: a=0, b=2, D^{w}: a=1, b=1; p, p′ are natural integers; x,y=0, 1 or 2, x+y=2, the mass ratio R^{w} (% by weight) of the alkenyl units to the total mass of the POS A_{2.3} is less than or equal to 0.5, preferably 0.3 and better still 0.2;
   and mixtures thereof;
(B) at least one cross-linking silicone oil comprising at least one hydrogenated POS having, per molecule, at least three hydrogen atoms bound to the silicon;
(C) at least one catalyst comprising at least one metal belonging to the platinum group;
(D) optionally at least one attachment promoting additive;
(E) optionally at least one cross-linking inhibitor;
(F) optionally an adhesion modulating system;
(G) optionally, at least one diluent;
(H) optionally, at least one other functional, in particular anti-misting, additive.

It is to the credit of the inventors to have judiciously selected the constituents of the alkenylated silicone component A, and in particular, of the fraction F2 of this novel silicone composition, in order to produce high-performance non-stick coatings on polymer supports, in particular of polyester, for example PET. Thanks to the invention, the coatings obtained have an excellent attachment (“rub-off), a sufficiently high peel force at high speed, good mechanical and physical properties (smoothness, transparency and good coefficient of friction).

The performances achieved by means of the invention in terms of quality of the cross-linking by polyaddition: reactivity/level of cross-linking/kinetics, are entirely useful, as evidenced by the low levels of extractables obtained, as regards the reactivity and the level of cross-linking.
It is to be noted that the properties of attachment to a support are all the more positive, as they last for long periods, for example at least two weeks, even under severe conditions, in particular of humidity and/or temperature.
These advantageous characteristics are can be exploited particularly for producing the non-stick property of polymer supports, in particular polyester, for example PET, which are useful as “liners” of self-adhesive labels (pressure-sensitive adhesive), being presented in the form of rolls or spools of films e.g. manufactured at very high speed.
This is all the more useful as these results are obtained with a silicone composition, where the rheological behaviour of the silicone composition is not affected (not too viscous), such that it is perfectly capable of being coated on any support and in particular on any flexible support and is very slightly or not at all subject to “misting” under industrial coating conditions.
Moreover, the silicone coating compositions according to the invention can advantageously be “solvent-free”. This means that they are free of solvent and, in particular, free of organic solvent. The advantages that this provides with regard to health and safety are easy to envisage.

Preferably, the composition according to the invention is characterized in that the fraction F1 of the alkenylated silicone component A represents at least 30% by weight of A, preferably at least 50%.

F1 is one of the main constituents of the composition according to the invention by weight.

In order to optimize the performances of the invention, it can be preferable for the oils A_{2.1} A_{2.2} A_{2.3} to be chosen such that in their simplified formulae: m/2, n and p/p′ are respectively greater than or equal to 70, preferably greater than or equal to 100.

Apart from the viscosity v2 of the oil (2.2) of F2 which is an important parameter of the invention, it is also advantageous for the viscosity, respectively v1, v3, of the oils A_{2.1} and A_{2.3} (in mPa·s at 25° C.) to be defined as follows:
400≦v1≦60,000, preferably 500≦v1≦50,000,
and better still 800≦v1≦30,000;
3000≦v2≦180,000, preferably 5000≦v2≦100,000,
and better still 5000≦v2≦3000;
800≦v3≦15000, preferably 1000≦v3≦10,000,
and better still 1000≦v3≦5000.

All the viscosities referred to in the present statement correspond to a so-called “Newtonian” measurable quantity of dynamic viscosity at 25° C., i.e. the dynamic viscosity which is measured, in a manner known per se, at a shear speed gradient which is sufficiently low for the viscosity measured to be independent of the speed gradient.

It has appeared particularly judicious according to the invention, for the composition to have an Si—H/Si-alkenyl molar ratio, such that:
1.0≦Si—H/Si-alkenyl≦7

preferably 1.5≦Si—H/Si-alkenyl≦5.

According to a useful embodiment of the invention, the mass ratio R^{w} (% by weight) of the Si-alkenyl units to the total mass of F2 with attachment promotion activity, is defined as follows:
for A_{2.1}
   0.05<R^{w}<0.2; preferably 0.07<R^{w}<0.15;
for A_{2.2}
   0.05<R^{w}<0.25; preferably 0.1<R^{w}<0.2.

Advantageously:
A2.1 is, for example, chosen from the group comprising the polydimethylsiloxanes having both (dimethyl)(vinyl)silyl ends and (trimethyl)(vinyl)silyl ends;
A2.2 is, for example, chosen from the group comprising the polydimethylsiloxanes having two (dimethyl)(vinyl)silyl ends;
A2.3 is, for example, chosen from the group comprising the poly(dimethylsiloxy)(methyl-vinylsiloxy)siloxanes with (dimethyl)-(vinyl)silyl ends.

The polyorganosiloxane (I.1) of the fraction F1 of the alkenylated silicone component can have a linear, branched or cyclic structure. Its degree of polymerization is, for example, comprised between 2 and 5 000.

Examples of siloxyl units of formula (I.1) are the vinyldimethylsiloxane unit, the vinylphenylmethylsiloxane unit and the vinylsiloxane unit.
Examples of polyorganosiloxanes (I.1) are the dimethylpolysiloxanes with dimethylvinylsilyl ends, the methylvinyldimethylpolysiloxane copolymers with trimethylsilyl ends, the methylvinyldimethylpolysiloxane copolymers with dimethylvinylsilyl ends, and the cyclic methylvinylpolysiloxanes.
The vinylated oils are commercial products conventionally utilized for preparing non-stick curable compositions (e.g. U.S. Pat. No. 4,623,700). The oils with heavier alkenyl or alkenyloxyalkylene groups are described in particular in the patents EP-B-O 219 720 and EP-A-0 454 130.

As regards the cross-linking silicone oil B, it can for example comprise at least one polyorganosiloxane (II.2) comprising the siloxyl units of formula:

$${H}_{d} {L}_{e} SiO \frac{4 - ( d + e )}{2} \qquad ( I .2 )$$

in which:
L is a monovalent hydrocarbon group with no unfavourable effect on the activity of the catalyst and chosen, preferably, from the alkyl groups having 1 to 8 carbon atoms, advantageously included among the methyl, ethyl, propyl and 3,3,3-trifluoropropyl groups as well as among the aryl groups and, advantageously, among the xylyl and totyl and phenyl radicals,
d is 1 or 2, e is 0, 1 or 2, d+e have a value comprised between 1 and 3.
   The dynamic viscosity ηd (at 25° C.) of this polyorganosiloxane (I.2)≧5 preferably 10 and, still more preferably, is comprised between 20 and 1000 mPa·s. The polyorganosiloxane (I.2) can have a linear, branched or cyclic structure. The degree of polymerization is greater than or equal to 2. More generally, it is less than or equal to 5,000.
   Examples of units of formula (I.2) are:

### M′: H(CH₃)₂SiO_{1/2}, D′: HCH₃SiO_{2/2}, D′: H(C₆H₅)SiO_{2/2}.

Examples of polyorganosiloxane (I.2), i.e. of cross-linking oil (B) are:
M′DD′: the dimethylpolysiloxanes with hydrogenodimethylsilyl ends, poly(dimethylsiloxy)(methylhydrogenosiloxy) α,ω-dimethylhydrogeno-siloxane,
MDD′: the copolymers with dimethyl-hydrogenomethylpolysiloxane units with trimethylsilyl ends,
M′DD″: the copolymers with dimethyl-hydrogenomethylpolysiloxane units with hydrogenodimethylsilyl ends,
MD′: the hydrogenomethylpolysiloxanes with trimethylsilyl ends,
D′₄: the cyclic hydrogenomethylpolysiloxanes.
   Examples of these cross-linking oils (B) are given in the U.S. Pat. No. 4,623,700 and the European patent EP-B-O 219 720.

Preferably, the cross-linking silicone oil B comprises:
at least one POS (B1) of the following average linear formula:

M_{α}M′_{β}D_{γ}D′_{δ}
with
   M=(R¹)₃SiO_{1/2}
   M′=Hₐ(R¹)_{b}SiO_{1/2}, a+b=3, a=1, 2 or 3, b=0 to 3
   D=(R²)₂SiO_{2/2}
   D′=HR³SiO_{2/2}
   R¹, R², R³ corresponding independently to the same definition as the group Z of formula (I.1);
having a viscosity v5 (in mPa·s at 25° C.) defined as follows:

5≦v5≦500, preferably 10≦v5≦200, and better still 10≦v5≦100
and having an Si—H titre (% by weight relative to this POS B1) defined as follows:
5≦Si—H≦46, preferably 20≦Si—H≦46, and better still 30≦Si—H≦46;
and/or at least one branched POS (B2) of the following average formula: M′ₕQₖ with
   M′=Hₐ(R¹)_{b}SiO_{1/2}, a+b=3, a=1, 2 or 3, b=0 to 3
   Q SiO_{4/2}
   4≦h≦20; 1≦k≦4 or 5
having a viscosity v5 (in mPa·s at 25° C.) defined as follows:
5≦v5′≦100, preferably 10≦v5′≦30;
and having an Si—H titre (% by weight relative to this POS B2) defined as follows:

15≦Si—H≦40, preferably 25≦Si—H≦35, and better still 25≦Si—H≦30.

According to a first variant of the preferred form (B1), α=2, β=0, δ+γ comprised between 10 and 200, preferably between 20 and 100, more preferably between 30 and 70, and better still γ=0.

According to a second variant of the preferred form of (B1):
0≦α≦2
0≦β≦2
0≦γ
0≦δ
0≦γ/δ, preferably 0≦γ/δ≦2; and still more preferably
   0≦γ/δ≦1.5;
15≦((β/δ)×1000≦150, preferably 15≦((β/δ)×1000≦80; and still more preferably 15≦(β/δ)×1000≦60.

The average linear formula of the cross-linking agent (B1) indicated above is a global formula which covers:
-a- cases where the cross-linking agent (B1) comprises the units M M′D D′ on the same (preferably linear) POS molecule, the cross-linking agent being able to comprise one or more different M M′D D′ molecules,
-b- cases where the cross-linking agent (B1) is formed by a mixture of (preferably linear) POS molecules each bearing some of the M M′D D′ units,
-c- cases where the cross-linking agent (B1) is formed by a mixture of (preferably linear) cross-linking agents (B1) of types -a- and -b-, as described above.

By way of examples of type -b- cross-linking agents (B1), there can be mentioned the mixtures of (B1) comprising M and D′ units and of POS comprising M, D and D′ units or mixtures of (B1) comprising M and D units and of POS comprising M′, D and D′ units, or mixtures of (B1) comprising M and D′ units and of POS comprising M and D units, or mixtures of (B1) comprising M′ and D′ units and of POS comprising M and D units.

The polyaddition silicone composition bases (A)(B) according to the invention may comprise only linear polyorganosiloxanes (I.1) and (I.2) such as, for example, those described in the patents: U.S. Pat. No. 3,220,972, U.S. Pat. No. 3,697,473 and U.S. Pat. No. 4,340,709.

The catalysts (C) are also well known. Compounds of platinum and rhodium are preferably used. It is possible, in particular, to use the complexes of platinum and of an organic product described in the U.S. Pat. No. 3,159,601, U.S. Pat. No. 3,159,602, U.S. Pat. No. 3,220,972 and the European patents EP-A-0 057 459, EP-A-0 188 978 and EP-A-0 190 530, the complexes of platinum and vinylated organosiloxanes described in the U.S. Pat. No. 3,419,593, U.S. Pat. No. 3,715,334, U.S. Pat. No. 3,377,432 and U.S. Pat. No. 3,814,730. The catalyst generally preferred is platinum. In this case, the quantity by weight of catalyst (II), calculated in weight of metal platinum, is generally comprised between 2 and 500 ppm, preferably between 5 and 200 ppm based on the total weight of the alkenylated silicone component (A) and of the cross-linking oil (B).

The attachment promoting additive (D) optionally present in the composition according to the invention, is preferably chosen from the epoxy-functional silanes, preferably from the group comprising:
(3,4-epoxycyclohexyl)ethyltriethoxy-silane [Coatosil® 1770],
Tris(3-(trimethoxysilyl)propyl)isocyanurate [A-Link 597],
GLYMO,
MEMO,
silicone compounds comprising both Sill and SiVi groups and epoxy-functional groups,
and mixtures thereof.

The suitable concentrations of additive (D) are, for example, comprised between 0.5 and 5%, preferably between 1 and 3%.

According to a preferred arrangement of the invention, the composition comprises at least one cross-linking inhibitor (E) chosen from the following compounds:
the polyorganosiloxanes, advantageously cyclic and substituted by at least one alkenyl, tetramethylvinyltetrasiloxane being particularly preferred,
pyridine,
the phosphines and organic phosphites,
the unsaturated amides,
the dialkyldicarboxylates (patents U.S. Pat. Nos. 4,256,870; 4,476,166),
the dialkylacetylenedicarboxylates (U.S. Pat. No. 4,347,346)
the alkylated maleates,
the diallylmaleates,
the acetylenic alcohols (U.S. Pat. Nos. 3,989,866; 4,336,364; 3,445,420),
and mixtures thereof.
   These acetylenic alcohols, (cf. FR-B-1 528 464 and FR-A-2 372 874), which are among the preferred thermal hydrosilylation reaction blockers, have the formula:

R⁴—(R⁵)C(OH)—C≡CH

a formula in which,

R⁴ is a linear or branched alkyl radical, or a phenyl radical;

R⁵ is H or a linear or branched alkyl radical, or a phenyl radical;

the R⁴, R⁵ radicals and the carbon atom situated at position a of the triple bond being able optionally to form a ring;
the total number of carbon atoms contained in R⁴ and R⁵ being at least 5, preferably 9 to 20.
Said alcohols are, preferably, chosen from those having a boiling point above 250° C. There can be mentioned as examples:
ethynyl-1-cyclohexanol 1;
methyl-3 dodecyne-1ol-3;
trimethyl-3,7,11 dodecyne-1 ol-3;
diphenyl-1,1 propyne-2 ol-1;
ethyl-3 ethyl-6 nonyne-1 ol-3;
methyl-3 pentadecyne-1 ol-3.
   These α-acetylenic alcohols are commercial products.
   Such a retarder is present in such a quantity that it inhibits the action of the catalyst at ambient temperature, this inhibiting action ceasing during the high-temperature cross-linking treatment; this quantity is generally of the order of 3000 ppm maximum, preferably at a rate of 100 to 2500 ppm with respect to the total weight of the alkenylated silicone component (A) and of the silicone oil (B), in particular, in the case where the hydrosilylation inhibiting agent is ethynylcyclohexanol.
   According to a variant, the non-stick cross-linkable silicone composition contains at least one adhesion modulating system (F).
   This adhesion modulating system (F) is selected from the known systems. These may be those described in the French patent FR-B-2 450 642, the U.S. Pat. No. 3,772,247 or the European patent application EP-A-0 601 938. By way of examples, there can be mentioned the modulators based on:
96 to 85 parts by weight of at least one reactive polyorganosiloxane resin (A) of type: MD^{Vi}Q, MM^{Vi}Q, MD^{Vi}T, MM^{Hexenyl}Q, or MM^{Allyloxypropyl}Q,
4 to 15 parts by weight of at least one non-reactive resin (B) of type: MD′Q, MDD′Q, MDT′, MQ, or MDQ.
   According to a preferred characteristic of the invention, the concentration of [POS (B)], in % by dry weight relative to the total mass of the composition, is defined as follows:
(F)]<20
preferably (F)]<15
and still more preferably (F)]<10.
   It has in fact been observed, within the framework of the invention, that the performances of the modulating system are optimized, to the extent that care is taken to introduce it into the non-stick silicone composition, in a quantity such that F does not represent more than 20% by dry weight, relative to the total mass of the composition.

The diluent (G) optionally present in the composition is advantageously chosen from the alpha olefins in particular those comprising 4 to 15 carbon atoms per molecule.

Other functional additives (H) can be incorporated in the composition. These additives can be chosen from the fillers such as for example glass microbeads, anti-“misting” agents etc.

Advantageously, the complete curable compositions ABC(D)(E)(G)(H)—the components (−) being optional—are fluid at normal temperature; their viscosity can be, for example, a viscosity v6 (in mPa·s at 25° C.) defined as follows:

100≦v6≦3,000, preferably 200≦v6≦2,000, and better still 500≦v6≦1,000.

The preparation of the silicone composition according to the invention, which can be used in particular as a coating base for producing non-stick and water-repellent coatings, this composition being of the type of that defined above, simply involves mixing the constituents ABC(D)(E)(F)(G)(H) using mixing means and methods known to a person skilled in the art.

The compositions according to the invention can be applied to flexible supports preferably formed by films of polymer plastic material selected from the polyolefins (e.g. polyethylene, polypropylene etc.) and/or from the polyesters (e.g. PET etc.) the latter being more particularly referred to. This does not however exclude other flexible supports such as papers of various types (supercalendered, layered etc.), cards, cellulose sheets, metal sheets etc.

The flexible supports made of polyester for example of the PET type coated with a non-stick silicone layer, are used as “liners” for adhesive labels.

According to another of its aspects, the invention relates to a process for producing a water-repellent and non-stick coating on a support, preferably a polymer film, more preferably a polymer film made of polyester, characterized in that it consist of applying to this support at least one layer of a silicone composition as defined above, and ensuring that this layer cross-links, preferably by activating it by heating.

These compositions can be applied using devices used on industrial paper coating machines such as a five-roll coating head, air-knife or equalizing bar systems, on flexible supports or materials, then cured by circulation in tunnel ovens heated to 70-200° C.; the time for passing through these ovens is a function of the temperature; it is generally of the order of 5 to 15 seconds at a temperature of the order of 100° C. and of the order of 1.5 to 3 seconds at a temperature of the order of 180° C.

The quantities of compositions applied are for example of the order of 0.5 to 2 g per m² of surface to be treated, which corresponds to the application of layers of the order of 0.5 to 2 μm.

The materials or supports thus coated can subsequently be brought into contact with any pressure-sensitive adhesive rubber, acrylic or other materials. The adhesive material can then be easily peeled from said support or material.

According to the invention, for the cross-linking of the coating, the support coated with the polyaddition silicone composition is placed at a temperature preferably less than or equal to 180° C. for less than 10 seconds.

Another subject of the invention also relates to a process for increasing the attachment (i.e. abrasion resistance) of a cross-linked/cured, water-repellent and non-stick silicone coating, applied to a support, preferably a polymer film, more preferably a polymer film made of polyester, and obtained from a silicone composition capable of cross-linking/curing by polyaddition and comprising:
(A) an alkenylated silicone component containing at least one functional silicone oil comprising at least one PolyOrganoSiloxane (POS) comprising units of formula:

$${W}_{a} {Z}_{b} SiO \frac{4 - ( a + b )}{2} \qquad ( I .1 )$$

in which:
W represents independently a functional alkenyl group, preferably C2-C6, and, still more preferably vinyl or allyl,
Z represents independently a monovalent hydrocarbon group, with no unfavourable effect on the activity of the catalyst and chosen, preferably, from the alkyl groups having 1 to 8 carbon atoms advantageously included among the methyl, ethyl, propyl and 3,3,3-trifluoropropyl groups as well as among the aryl groups and, advantageously, among the xylyl and totyl and phenyl radicals,
a is 1 or 2, b is 0, 1 or 2 and a+b is comprised between 1 and 3;
(B) at least one cross-linking silicone oil comprising at least one hydrogenated POS having, per molecule, at least three hydrogen atoms bound to the silicon;
(C) at least one catalyst comprising at least one metal belonging to the platinum group;
(D) optionally at least one attachment promoting additive;
(E) optionally at least one cross-linking inhibitor;
(F) optionally, an adhesion modulating system;
(G) optionally, at least one diluent;

(H) optionally, at least one other functional additive, in particular anti-misting;
and mixtures thereof;
   characterized in that it involves using a silicone composition the alkenylated silicone component A of which comprises a fraction F1 and a fraction F2, different from one another,
fraction F1 comprising at least one alkenylated silicone oil chosen from the group comprising at least one linear POS having, per molecule, at least two alkenyl groups (preferably C2-C6) bound to the silicon,
   of average linear formula: M^{w}ᵣ(D)_{q}(D^{w})_{q′}M_{r′} in which M and D are siloxy units of formula (I.1) with for M: a=0, b=3, for M^{w}: a=1, b=2 and for D: a=0, b=2, D^{w}: a=1, b=1; q and q′ are natural integers, r,r′=0, 1 or 2 with r+r′=2;
   of viscosity v4 (in mPa·s at 25° C.) defined as follows:
   75≦v4≦4,000, preferably 100≦v4≦2,000, and better still 100≦v4≦1,000
   and with a mass ratio R^{w} (% by weight) of the Si-alkenyl units to the total mass of the POS of the fraction F1 of A is defined as follows:
      0.1≦R^{w}≦3.5, preferably 0.2≦R^{w}≦3, and better still 0.5≦R^{w}≦3,
F2 having an activity which promotes the adhesion to the supports (therefore abrasion resistance) of the non-stick coatings obtained by curing/cross-linking of the composition,
and F2 being formed by at least one alkenylated silicone oil chosen from the group comprising:
   (A_{2.1}) the monoalkenylated silicone oils each comprising at least one linear POS having, per molecule, a single end bearing a single alkenyl group (preferably C₂-C₆) bound to the silicon, and of average linear formula M^{w}DₘM in which M, M^{w} and D are siloxy units of formula (I.1) with for M: a=0, b=3; M^{w}: a=1, b=2 and for D: a=0, b=2; and m is a natural integer greater than or equal to 150;
   (A_{2.2}) the long silicone oils each comprising at least one linear POS having, per molecule, at each of its ends an alkenyl group (preferably C₂-C₆) bound to the silicon and of average linear formula M^{w}DₙM^{w} in which M^{w} and D are siloxy units of formula (I.1) with for M^{w}: a=1, b=2 and for D: a=0, b=2; and n is a natural integer greater than or equal to 250; the viscosity v2 of said oils A_{2.2} being comprised between 3000 and 200,000 mPa·s;
   (A_{2.3}) the “weakly” alkenylated silicone oils each comprising at least one linear POS having, per molecule, at least one alkenyl group (preferably C₂-C₆ bound to the silicon, of average linear formula
   (M^{w})ₓ(M)_{y}(D)ₚ(D^{w})ₚ, in which M, M^{w} and D are siloxy units of formula (I.1) with for M,M^{w}: a=1, b=2 and for D: a=0, b=2, D^{w}: a=1, b=1; p, p′ are natural integers; x,y=0, 1 or 2, x+y=2, the mass ratio R^{w} (% by weight) of the alkenyl units to the total mass of the POS A_{2.3} is less than or equal to 0.5, preferably 0.3 and better still 0.2;
   and mixtures thereof.

Finally, the invention relates to a support, preferably a polymer film, more preferably a polymer film made of polyester characterized in that it comprises at least one water-repellent and non-stick coating based on a silicone composition cross-linked/cured by polyaddition and comprising:
(A) an alkenylated silicone component containing at least one functional silicone oil comprising at least one PolyOrganoSiloxane (POS) comprising units of formula:

$${W}_{a} {Z}_{b} SiO \frac{4 - ( a + b )}{2} \qquad ( I .1 )$$

in which:
   W represents independently a functional alkenyl group, preferably C2-C6, and, still more preferably vinyl or allyl,
   Z represents independently a monovalent hydrocarbon group, with no unfavourable effect on the activity of the catalyst and chosen, preferably, from the alkyl groups having 1 to 8 carbon atoms advantageously included among the methyl, ethyl, propyl and 3,3,3-trifluoropropyl groups as well as among the aryl groups and, advantageously, among the xylyl and totyl and phenyl radicals,
   a is 1 or 2, b is 0, 1 or 2 and a+b is comprised between 1 and 3;
      this alkenylated silicone component A comprising a fraction F1 and a fraction F2 which are different from one another,
fraction F1 comprising at least one alkenylated silicone oil chosen from the group comprising at least one linear POS having, per molecule, at least two alkenyl groups (preferably C₂-C₆) bound to the silicon,
   of average linear formula: M^{w}ᵣ(D)_{q}(D^{w})_{q′}M_{r′} in which M and D are siloxy units of formula (I.1) with for M: a=0, b=3, for M^{w}: a=1, b=2 and for D: a=0, b=2, D^{w}: a=1, b 1; q and q′ are natural integers, r,r′=0, 1 or 2 with r+r′=2;
   of viscosity v4 (in mPa·s at 25° C.) defined as follows:
   75≦v4≦4,000, preferably 100≦v4≦2,000, and better still 100≦v4≦1,000
   and with a mass ratio R^{w} (% by weight) of the Si-alkenyl units to the total mass of the POS of the fraction F1 of A is defined as follows:
      0.1≦R^{w}≦3.5, preferably 0.2≦R^{w}≦3, and better still 0.5≦R^{w}≦3,
F2 having an activity which promotes the adhesion to the supports (therefore abrasion resistance) of the non-stick coatings obtained by curing/cross-linking of the composition,
and F2 being formed by at least one alkenylated silicone oil chosen from the group comprising:
   (A_{2.1}) the monoalkenylated silicone oils each comprising at least one linear POS having, per molecule, a single end bearing a single alkenyl group (preferably C₂-C₆) bound to the silicon, and of average linear formula M^{w}DₘM in which M, M^{w} and D are siloxy units of formula (I.1) with for M: a=0, b=3; M^{w}: a=1, b=2 and for D: a=0, b=2; and m is a natural integer greater than or equal to 150;
   (A₂₂) the long silicone oils each comprising at least one linear POS having, per molecule, at each of its ends an alkenyl group (preferably C₂-C₆) bound to the silicon and of average linear formula M^{w}DₙM^{w} in which M^{w} and D are siloxy units of formula (I.1) with for M^{w}: a=1, b=2 and for D: a=0, b=2; and n is a natural integer greater than or equal to 250; the viscosity v2 of said oils A_{2.2} being comprised between 3000 and 200,000 mPa·s;
   (A_{2.3}) the “weakly” alkenylated silicone oils each comprising at least one linear POS having, per molecule, at least one alkenyl group (preferably C₂-C₆) bound to the silicon, of average linear formula
   (M^{w})ₓ(M)_{y}(D)ₚ(D^{w})ₚ, in which M, M^{w} and D are siloxy units of formula (I.1) with for M, M^{w}: a=1, b=2 and for D: a=0, b=2, D^{w}: a=1, b=1; p, p′ are natural integers; x,y=0, 1 or 2, x+y=2, the mass ratio R^{w} (% by weight) of the alkenyl units to the total mass of the POS A_{2.3} is less than or equal to 0.5, preferably 0.3 and better still 0.2;
   and mixtures thereof.
(B) at least one cross-linking silicone oil comprising at least one hydrogenated POS having, per molecule, at least three hydrogen atoms bound to the silicon;
(C) at least one catalyst comprising at least one metal belonging to the platinum group;
(D) optionally at least one attachment promoting additive;
(E) optionally at least one cross-linking inhibitor;
(F) optionally, an adhesion modulating system;
(G) optionally, at least one diluent;
(H) optionally, at least one other functional additive, in particular anti-misting.
   The constituents ABC(D)(E)(F)(G)(H) are as described above.
   The non-stick silicone coatings according to the invention are well and durably attached to the flexible supports in particular of PET, even under harsh humidity and temperature conditions. They are cross-linked/cured (few extractables). They have a peel force profile such that the peeling force remains high even at high speed (good non-stick quality). They are smooth and transparent, which leads to their being made into high-performance label supports.
   The following examples are given as an indication and cannot be considered as limiting the field and inventiveness of the invention.

### EXAMPLES

The silicone coating is produced on a Rotomec pilot coating machine at 100 m/min (3.6 seconds residence time in the ovens at 180° C.) on a polyester support film with a thickness of 36 microns (Luminor 6001) marketed by Toray.
The temperature of the silicone layer is monitored in line at approximately 140° C. using an infrared camera.
The coating is characterized after coating and cross-linking by the following tests:
Weight of the silicone coating: Using a radioactive source or a fluorescent X-ray tube, the silicon atoms of the coating are excited and the X-ray intensity re-emitted by the coating is measured. On the basis of a calibration the weight of the silicone coating is thus determined. The apparatus used has the reference Lab X1000 marketed by Oxford.
Level of extractables (leaving the coating machine: “in-line”/4 days after the cross-linking: “off-line”): the test involves immersing the coating in methylisobutylketone then analysis by Perkin Elmer 3100 atomic absorption spectrophotometry; on a coating leaving the (“in line”) coating machine.
On the basis of a calibration, the level of silicon extractable from the coating is found.
Attachment to the support: “rub off” test. In practice the surface of the coating is rubbed with a finger and the number of passes after which the coating degrades/peels is noted. A score of 10 (10 passes) is considered as acceptable for use.
Peel force (peeling): the test used corresponds to Finat standards Nos. 3 and 10 of edition No. 5 of 1999. This test is carried out 4 days after the (“off-line”) cross-linking with adhesive strips marketed under the trade mark Tesa® 7475 at 23° C. (acrylic base), Tesa® 7476 at 70° C. (rubber base).

### Products Used:

### Abbreviations:

### M=(CH₃)₃SiO_{1/2}

### M*=(CH₃)₂(Vi)SiO_{1/2}

### D=(CH₃)₃SiO_{2/2}

### D*=(CH₃)(Vi) SiO_{2/2}

Vi=vinyl
FRACTION F1: Pol 1=siloxanic polymer of structure M₂DₙD*ₘ of viscosity 500 mPa·s titrating 0.9% Vi by weight
FRACTION F2 A2.1: Pol 2=siloxanic polymer of structure M*₂Dₙ of viscosity 10 Pa.s
FRACTION F2 A2.2: Pol 3=siloxanic polymer of structure MM*Dₙ of viscosity 900 mPa·s titrating 0.08% Vi by weight
FRACTION F2 A2.2: Pol 4=siloxanic polymer of structure MM*Dₙ of viscosity 30 Pa.s titrating 0.025% Vi by weight
FRACTION F2 A2.3: Pol 5=siloxanic polymer of structure M₂DₙD*ₘ of viscosity 2900 mPa·s titrating 0.25% Vi by weight
NON-ALKENYLATED SILICONE OIL: Pol 6=siloxanic polymer of structure M₂Dₙ of viscosity 350 mPa·s
CROSS-LINKING SILICONE OIL XL=siloxanic polymer of structure M₂D′ₙ titrating 46% SiH by weight
Add D=epoxycyclohexyl-ethyl triethoxysilane
Cross-linking inhibitor E=ethynylcyclohexanol
Cat C=Karstedt catalyst titrating 10% platinum by weight

### Examples 1 to 14

### A—Compositions

TABLE 1

| | Pol 1 | Pol 2 | Pol 3 | Pol 4 | Pol 5 | Pol 6 | XL | Add | Cross | Cat |
|---|---|---|---|---|---|---|---|---|---|---|
| Example | p | p | p | p | p | p | p | p | p | ppm Pt |
| comp 1 | 100 | | | | | | 7 | | 0.15 | 120 |
| comp 2 | 100 | | | | | | 13 | | 0.15 | 120 |
| 3 | 50 | 50 | | | | | 4 | | 0.15 | 120 |
| 4 | 50 | 50 | | | | | 8 | | 0.15 | 120 |
| 5 | 75 | 25 | | | | | 10 | | 0.15 | 120 |
| comp 6 | | | 100 | | | | 1.5 | | 0.15 | 120 |
| 7 | 50 | | 50 | | | | 5 | | 0.15 | 120 |
| 8 | 75 | | 25 | | | | 6 | | 0.15 | 120 |
| 9 | 75 | | | 25 | | | 6 | | 0.15 | 120 |
| comp 10 | | | | | 100 | | 7 | | 0.15 | 120 |
| 11 | 50 | | | | 50 | | 4 | | 0.15 | 120 |
| comp 12 | 100 | | | | | 3 | 7 | | 0.15 | 120 |
| 13 | 50 | 50 | | | | | 8 | 2 | 0.15 | 120 |
| 14 | 75 | 25 | | | | | 10 | 2 | 0.15 | 120 |

1 comp, 2 comp and 12 comp are examples of comparative compositions which comprise no fraction F2 including one or more attachment promoting polymers.

### B—The Tests and their Results

TABLE 2

| | | rub-off after | | | | | | | |
|---|---|---|---|---|---|---|---|---|---|
| | | storage of the | | | | | | | |
| | | liner + adhesive | | | | | | | |
| | | at 50° C. RH70 | | | | | | | Peeling |
| Example | % extr. | 3 days | 5 days | 7 days | 10 days | 14 days | 22 days | 34 days | g/inch |
| comp 1 | | >10 | 2 | | | | | | 75 |
| comp 2 | | >10 | 5 | | | | | | 170 |
| 3 | 2.1 | >10 | >10 | 5 | | | | | 46 |
| 4 | 2.1 | >10 | >10 | >10 | 2 | | | | 150 |
| 5 | 2.5 | >10 | >10 | 4 | | | | | 100 |
| comp 6 | 9.6 | >10 | >10 | >10 | >10 | >10 | >10 | >10 | 250 |
| 7 | 5.1 | >10 | >10 | 4 | | | | | 85 |
| 8 | 4.7 | >10 | 3 | | | | | | 70 |
| 9 | 3.6 | >10 | >10 | >10 | 5 | | | | 68 |
| comp 10 | 7 | >10 | >10 | >10 | >10 | 8 | | | 115 |
| 11 | 4.7 | >10 | 3 | | | | | | 85 |
| comp 12 | 8.9 | >10 | | 1 | | | | | |
| 13 | 2.8 | >10 | >10 | >10 | >10 | >10 | >10 | 8 | |
| 14 | 2.5 | >10 | >10 | >10 | >10 | >10 | >10 | 7 | |

### Comments:

Comp1 and Comp2: examples with an alkenylated silicone component A constituted solely by the fraction F1. An insignificant gain is observed on the “Rub-off” (RO) attachment provided by an excess of cross-linking agent B in the example comp2.

### Examples 3-4-5

### Fraction F1 and Long Oil A2.1

Improvement of the RO, especially when the level of cross-linking agent B is high.

### Examples Comp6-7-8

Ex. comp6: monoalkenylated oil A2.2.
Ex. 7: fraction F1 and monoalkenylated oil at the end of chain A2.2.
Ex. 8: fraction F1 and smaller quantity of monoalkenylated oil at the end of chain A2.2.
The higher the concentration of A2.2, the better the RO.

### Example 9

### Fraction F1 and Monoalkenylated Oil A2.2 which is More Viscous than in the Examples 6, 7 and 8

Good RO performance, even at a low content.

### Examples Comp10 and 11

Ex. comp10: “weakly” alkenylated oil A2.3
Ex. 11: fraction F1 and “weakly” alkenylated oil A2.3
The higher the concentration of A2.3, the better the RO.

### Comp12

Contrary-example with non-alkenylated oil: no effect.

### Examples 13 and 14

Ex. 13: fraction F1, long oil A2.1 and adhesion promoting additive (D).
Ex. 14: fraction F1, long oil A2.1 and adhesion promoting additive (D).
Good performance RO, even at a low level of long oil A2.1.

1. Silicone composition capable of cross-linking/curing by polyaddition, to form a coating which is water-repellent and non-stick for supports preferably in the form of polymer films, characterized in that it comprises:
(A) an alkenylated silicone component containing at least one functional silicone oil comprising at least one PolyOrganoSiloxane (POS) comprising units of formula:
$${W}_{a} {Z}_{b} SiO \frac{4 - ( a + b )}{2} \qquad ( I .1 )$$
in which:
W represents independently a functional alkenyl group, preferably C2-C6, and, still more preferably vinyl or allyl,
Z represents independently a monovalent hydrocarbon group, with no unfavourable effect on the activity of the catalyst and chosen, preferably, from the alkyl groups having 1 to 8 carbon atoms advantageously included among the methyl, ethyl, propyl and 3,3,3-trifluoropropyl groups as well as among the aryl groups and, advantageously, among the xylyl and totyl and phenyl radicals,
a is 1 or 2, b is 0, 1 or 2 and a+b is comprised between 1 and 3;
this alkenylated silicone component A comprising a fraction F1 and a fraction F2 which are different from one another,
fraction F1 comprising at least one alkenylated silicone oil chosen from the group comprising at least one linear POS having, per molecule, at least two alkenyl groups (preferably C₂-C₆) bound to the silicon,
of average linear formula: M^{w}ᵣ(D)_{q}(D^{w})_{q′}M_{r′} in which M and D are siloxy units of formula (I.1) with for M: a=0, b=3, for M^{w}: a=1, b=2 and for D: a=0, b=2, D^{w}: a=1, b=1; q and q′ are natural integers, r,r′=0, 1 or 2 with r+r′=2;
of viscosity v4 (in mPa·s at 25° C.) defined as follows:
75≦v4≦4,000, preferably 100≦v4≦2,000,
and better still 100≦v4≦1,000
and with a mass ratio R^{w} (% by weight) of the Si-alkenyl units to the total mass of the POS of the fraction F1 of A is defined as follows:
0.1≦R^{w}≦3.5, preferably 0.2≦R^{w}≦3,
and better still 0.5≦R^{w}≦3,
F2 having an activity which promotes the adhesion on the supports (therefore of the abrasion resistance) of the non-stick coatings obtained by curing/cross-linking of the composition,
and F2 being formed by at least one alkenylated silicone oil chosen from the group comprising:
(A_{2.1}) the monoalkenylated silicone oils each comprising at least one linear POS having, per molecule, a single end bearing a single alkenyl group (preferably C₂-C₆) bound to the silicon, and of average linear formula M^{w}DₘM in which M, M^{w} and D are siloxy units of formula (I.1) with for M: a=0, b=3; M^{w}: a=1, b=2 and for D:
a=0, b=2; and m is a natural integer greater than or equal to 150;
(A_{2.2}) the long silicone oils each comprising at least one linear POS having, per molecule, at each of its ends an alkenyl group (preferably C₂-C₆) bound to the silicon and of average linear formula M^{w}DₙM^{w} in which M^{w} and D are siloxy units of formula (I.1) with for M^{w}: a=1, b=2 and for D: a=0, b=2; and n is a natural integer greater than or equal to 250; the viscosity v2 of said oils A_{2.2} being comprised between 3000 and 180,000 mPa·s;
(A_{2.3}) the “weakly” alkenylated silicone oils each comprising at least one linear POS having, per molecule, at least one alkenyl group (preferably C₂-C₆) bound to the silicon, of average linear formula (M^{w})ₓ(M)_{y}(D)ₚ(D^{w})_{p′} in which M, M^{w} and D are siloxy units of formula (I.1) with for M,M^{w}: a=1, b=2 and for D: a=0, b=2, D^{w}: a=1, b=1; p, p′ are natural integers; x,y=0, 1 or 2, x+y=2, the mass ratio R^{w} (% by weight) of the alkenyl units to the total mass of the POS A_{2.3} is less than or equal to 0.5, preferably 0.3 and better still 0.2;
and mixtures thereof;
(B) at least one cross-linking silicone oil comprising at least one hydrogenated POS having, per molecule, at least three hydrogen atoms bound to the silicon;
(C) at least one catalyst comprising at least one metal belonging to the platinum group;
(D) optionally at least one attachment promoting additive;
(E) optionally at least one cross-linking inhibitor;
(F) optionally an adhesion modulating system;
(G) optionally, at least one diluent;
(H) optionally, at least one other functional, in particular anti-misting, additive.

2. Composition according to claim 1, characterized in that the fraction F1 of the alkenylated silicone component A represents at least 30% by weight of A, preferably at least 50%.

3. Composition according to claim 1, characterized in that the oils A_{2.1} A_{2.2} A_{2.3} are chosen such that in their simplified formulae: m/2, n and p/p′ are respectively greater than or equal to 70, preferably greater than or equal to 100.

4. Composition according to claim 1, characterized in that the viscosity, respectively v1, v2, v3, of the oils A_{2.1}, A_{2.2} and A_{2.3} (in mPa·s at 25° C.) is defined as follows:
400≦v1≦60,000, preferably 500≦v1≦50,000,
and better still 800≦v1≦30,000;
4 3000≦v2≦180,000, preferably 5000≦v2≦100,000,
and better still 5000≦v2≦3000;
800≦v3≦15000, preferably 1000≦v3≦10,000,
and better still 1000≦v3≦5000.

5. Composition according to claim 1, characterized by an Si—H/Si-alkenyl molar ratio, such that:
1.0≦Si—H/Si-alkenyl≦7
preferably 1.5≦Si—H/Si-alkenyl≦5.

6. Composition according to claim 1, characterized in that the mass ratio R^{w} (% by weight) of the Si-alkenyl units to the total mass of F2 is defined as follows:
for A_{2.1}
0.05<R^{w}<0.2; preferably 0.07<R^{w}<0.15;
for A_{2.2}
0.05<R^{w}<0.25; preferably 0.1<R^{w}<0.2.

7. Composition according to claim 1, characterized in that the cross-linking silicone oil B comprises:
at least one POS (B1) of the following average linear formula:
M_{α}M′_{β}D_{γ}D′_{δ}
with
M=(R¹)₃SiO_{1/2}
M′=Hₐ(R¹)_{b}SiO_{1/2}, a+b=3, a=1, 2 or 3, b=0 to 3
D=(R²)₂SiO_{2/2}
D′=HR³SiO_{2/2}
R¹, R², R³ corresponding independently to the same definition as the group Z of formula (I.1);
α=2, β=0, δ+γ comprised between 10 and 200, preferably between 20 and 100, more preferably between 30 and 70, and better still γ=0;
or
0≦α≦2, 0 ≦β≦2, 0≦γ, 0<δ
0≦γ/δ, preferably 0≦γ/δ≦2, and still more preferably
0≦γ/δ≦1.5;
15≦(β/δ)×1000≦150, preferably 15≦((β/δ)×1000≦80; and
still more preferably 15≦(β/δ)×1000≦60
having a viscosity v5 (in mPa·s at 25° C.) defined as follows:
5≦v5≦500, preferably 10≦v5≦200, and better still 10≦v5≦100
and having an Si—H titre (% by weight relative to this POS B1) is defined as follows:
5≦Si—H≦46, preferably 20≦Si—H≦46, and better still 30≦Si—H≦46;
and/or at least one branched POS (B2) of the following average formula: M′ₕQₖ with
M′=Hₐ(R¹)_{b}SiO_{1/2}, a b=3, a=1, 2 or 3, b=0 to 3
Q=SiO_{4/2}
4≦h≦20; 1≦k≦4 or 5
having a viscosity v5 (in mPa·s at 25° C.) defined as follows:
5≦v5′≦100, preferably 10≦v5′≦30;
and having an Si—H titre (% by weight relative to this POS B2) is defined as follows:
15≦Si—H≦40, preferably 25≦Si—H≦35, and better still 25≦Si—H≦30.

8. Composition according to claim 1, characterized by a viscosity v6 (in mPa·s at 25° C.) defined as follows:
100≦v6≦3,000, preferably 200≦v6≦2,000,
and better still 500≦v6≦1,000.

9. Composition according to claim 1, characterized in that it comprises at least one attachment promoting additive (D) chosen from the epoxy-functional silanes, preferably from the group comprising:
(3,4-epoxycyclohexyl)ethyltriethoxy-silane [Coatosil® 1770],
Tris(3-(trimethoxysilyppropypisocyanurate [A-Link 597],
GLYMO,
MEMO,
silicone compounds comprising both SiH and SiVi groups and epoxy-functional groups,
and mixtures thereof.

10. Process for producing a water-repellent and non-stick coating on a support, preferably a polymer film, more preferably a polymer film made of polyester, characterized in that it involves applying to this support at least one layer of a silicone composition according to claim 1, and ensuring that this layer cross-links, preferably by activating it by heating.

11. Process for increasing the attachment (i.e. abrasion resistance) of a cross-linked/cured, water-repellent and non-stick silicone coating, applied to a support, preferably a polymer film, more preferably a polymer film made of polyester, and obtained from a silicone composition capable of cross-linking/curing by polyaddition and comprising:
(A) an alkenylated silicone component containing at least one functional silicone oil comprising at least one PolyOrganoSiloxane (POS) comprising units of formula:
$${W}_{a} {Z}_{b} SiO \frac{4 - ( a + b )}{2} \qquad ( I .1 )$$
in which:
W represents independently a functional alkenyl group, preferably C2-C6, and, still more preferably vinyl or allyl,
Z represents independently a monovalent hydrocarbon group, with no unfavourable effect on the activity of the catalyst and chosen, preferably, from the alkyl groups having 1 to 8 carbon atoms advantageously included among the methyl, ethyl, propyl and 3,3,3-trifluoropropyl groups as well as among the aryl groups and, advantageously, among the xylyl and totyl and phenyl radicals,
a is 1 or 2, b is 0, 1 or 2 and a+b is comprised between 1 and 3;
(B) at least one cross-linking silicone oil comprising at least one hydrogenated POS having, per molecule, at least three hydrogen atoms bound to the silicon;
(C) at least one catalyst comprising at least one metal belonging to the platinum group;
(D) optionally at least one attachment promoting additive;
(E) optionally at least one cross-linking inhibitor;
(F) optionally, an adhesion modulating system;
(G) optionally, at least one diluent;
(H) optionally, at least one other functional additive, in particular anti-misting;
and mixtures thereof;
characterized in that it involves using a silicone composition the alkenylated silicone component A of which comprises a fraction F1 and a fraction F2, different from one another,
fraction F1 comprising at least one alkenylated silicone oil chosen from the group comprising at least one linear POS having, per molecule, at least two alkenyl groups (preferably C2-C6) bound to the silicon,
of average linear formula: M^{w}ᵣ(D)_{q}(D^{w})_{q′}M_{r′} in which M and D are siloxy units of formula (I.1) with for M: a=0, b=3, for M^{w}: a=1, b=2 and for D: a=0, b=2, D^{w}: a=1, b=1; q and q′ are natural integers, r,r′=0, 1 or 2 with r+r′=2;
of viscosity v4 (in mPa·s at 25° C.) defined as follows:
75≦v4≦4,000, preferably 100≦v4≦2,000, and better still 100≦v4≦1,000
and with a mass ratio R^{w} (% by weight) of the Si-alkenyl units to the total mass of the POS of the fraction F1 of A is defined as follows:
0.1≦R^{w}≦3.5, preferably 0.2≦R^{w}≦3, and better still 0.5≦R^{w}≦3,
F2 having an activity which promotes the adhesion to the supports (therefore abrasion resistance) of the non-stick coatings obtained by curing/cross-linking of the composition,
and F2 being formed by at least one alkenylated silicone oil chosen from the group comprising:
(A_{2.1}) the monoalkenylated silicone oils each comprising at least one linear POS having, per molecule, a single end bearing a single alkenyl group (preferably C₂-C₆) bound to the silicon, and of average linear formula M^{w}DₘM in which M, M^{w} and D are siloxy units of formula (I.1) with for M: a=0, b=3; M^{w}: a=1, b=2 and for D: a=0, b=2; and m is a natural integer greater than or equal to 150;
(A_{2.2}) the long silicone oils each comprising at least one linear POS having, per molecule, at each of its ends an alkenyl group (preferably C₂-C₆) bound to the silicon and of average linear formula M^{w}DₙM^{w} in which M^{w} and D are siloxy units of formula (I.1) with for M^{w}: a=1, b=2 and for D: a=0, b=2; and n is a natural integer greater than or equal to 250; the viscosity v2 of said oils A_{2.2} being comprised between 3000 and 200,000 mPa·s;
(A_{2.3}) the “weakly” alkenylated silicone oils each comprising at least one linear POS having, per molecule, at least one alkenyl group (preferably C₂-C₆) bound to the silicon, of average linear formula
(M^{w})ₓ(M)_{y}(D)ₚ(D^{w})ₚ, in which M, M^{w} and D are siloxy units of formula (I.1) with for M,M^{w}: a=1, b=2 and for D: a=0, b=2, a=1, b=1; p, p′ are natural integers; x,y=0, 1 or 2, x+y=2, the mass ratio R^{w} (% by weight) of the alkenyl units to the total mass of the POS A_{2.3} is less than or equal to 0.5, preferably 0.3 and better still 0.2;
and mixtures thereof.

12. Support, preferably a polymer film, more preferably a polymer film made of polyester characterized in that it comprises at least one water-repellent and non-stick coating based on a silicone composition cross-linked/cured by polyaddition and comprising:
(A) an alkenylated silicone component containing at least one functional silicone oil comprising at least one PolyOrganoSiloxane (POS) comprising units of formula:
$${W}_{a} {Z}_{b} SiO \frac{4 - ( a + b )}{2} \qquad ( I .1 )$$
in which:
W represents independently a functional alkenyl group, preferably C2-C6, and, still more preferably vinyl or allyl,
Z represents independently a monovalent hydrocarbon group, with no unfavourable effect on the activity of the catalyst and chosen, preferably, from the alkyl groups having 1 to 8 carbon atoms advantageously included among the methyl, ethyl, propyl and 3,3,3-trifluoropropyl groups as well as among the aryl groups and, advantageously, among the xylyl and totyl and phenyl radicals,
a is 1 or 2, b is 0, 1 or 2 and a+b is comprised between 1 and 3;
this alkenylated silicone component A comprising a fraction F1 and a fraction F2 which are different from one another,
fraction F1 comprising at least one alkenylated silicone oil chosen from the group comprising at least one linear POS having, per molecule, at least two alkenyl groups (preferably C₂-C₆) bound to the silicon,
of average linear formula: M^{w}ᵣ(D)_{q}(D^{w})_{q′}M_{r′} in which M and D are siloxy units of formula (I.1) with for M: a=0, b=3, for M^{w}: a=1, b=2 and for D: a=0, b=2, D^{w}: a=1, b=1; q and q′ are natural integers, r,r′=0, 1 or 2 with r+r′=2;
of viscosity v4 (in mPa·s at 25° C.) defined as follows:
75≦v4≦4,000, preferably 100≦v4≦2,000, and better still 100≦v4≦1,000
and with a mass ratio R^{w} (% by weight) of the Si-alkenyl units to the total mass of the POS of the fraction F1 of A is defined as follows:
0.1≦R^{w}≦3.5, preferably 0.2≦R^{w}≦3, and better still 0.5≦R^{w}≦3,
F2 having an activity which promotes the adhesion to the supports (therefore abrasion resistance) of the non-stick coatings obtained by curing/cross-linking of the composition,
and F2 being formed by at least one alkenylated silicone oil chosen from the group comprising:
(A_{2.1}) the monoalkenylated silicone oils each comprising at least one linear POS having, per molecule, a single end bearing a single alkenyl group (preferably C₂-C₆) bound to the silicon, and of average linear formula M^{w}DₘM in which M, M^{w} and D are siloxy units of formula (I.1) with for M: a=0, b=3; M^{w}: a=1, b=2 and for D: a=0, b=2; and m is a natural integer greater than or equal to 150;
(A_{2.2}) the long silicone oils each comprising at least one linear POS having, per molecule, at each of its ends an alkenyl group (preferably C₂-C₆) bound to the silicon and of average linear formula M^{w}DₙM^{w} in which M^{w} and D are siloxy units of formula (IA) with for M^{w}: a=1, b=2 and for D: a=0, b=2; and n is a natural integer greater than or equal to 250; the viscosity v2 of said oils A_{2.2} being comprised between 3000 and 200,000 mPa·s;
(A_{2.3}) the “weakly” alkenylated silicone oils each comprising at least one linear POS having, per molecule, at least one alkenyl group (preferably C₂-C₆) bound to the silicon, of average linear formula
(M^{w})ₓ(M)_{y}(D)ₚ(D^{w})ₚ, in which M, M^{w} and D are siloxy units of formula (I.1) with for M,M^{w}: a=1, b=2 and for D: a=0, b=2, D^{w}: a=1, b=1; p, p′ are natural integers; x,y=0, 1 or 2, x+y=2, the mass ratio R^{w} (% by weight) of the alkenyl units to the total mass of the POS A_{2.3} is less than or equal to 0.5, preferably 0.3 and better still 0.2;
and mixtures thereof.
(B) at least one cross-linking silicone oil comprising at least one hydrogenated POS having, per molecule, at least three hydrogen atoms bound to the silicon;
(C) at least one catalyst comprising at least one metal belonging to the platinum group;
(D) optionally at least one attachment promoting additive;
(E) optionally at least one cross-linking inhibitor;
(F) optionally, an adhesion modulating system;
(G) optionally, at least one diluent;
(H) optionally, at least one other functional additive, in particular anti-misting.
